(19) United States
(12) Patent Application Publication
(10) Pub. No.: US 2025/0383525 A1
(43) Pub. Date: Dec. 18, 2025

(54) FOCUS COMPENSATION METHOD AND PROJECTOR DEVICE

(71) Applicant: QISDA CORPORATION, Taoyuan City (TW)

(72) Inventors: Jia-Ming Zhang, Taichung City (TW); Mao-Teng Ho, Taoyuan City (TW); Ching-Tze Huang, Taoyuan City (TW)

(73) Assignee: QISDA CORPORATION, Taoyuan City (TW)

(21) Appl. No.: 19/019,522

(22) Filed: Jan. 14, 2025

(30) Foreign Application Priority Data
Jun. 18, 2024 (TW) 113122445

(51) Int. Cl. G02B 7/28; G03B 21/14

(52) U.S. Cl. CPC G02B 7/282; G03B 21/142

(57) ABSTRACT

A focus compensation method is applied to a non-fixed focus lens of a projector device. The non-fixed focus lens includes a zooming module and a focusing module. The focus compensation method includes utilizing the zooming module to acquire a zooming angle of the non-fixed focus lens, acquiring a transformation relation between the zooming angle and a focusing angle of the non-fixed focus lens, acquiring a focused correction parameter of the non-fixed focus lens relevant to the zooming angle in accordance with the transformation relation, and utilizing the focused correction parameter to amend the focusing module for backlash compensation of an auto focusing function of the non-fixed focus lens. The zooming module is not synchronized with the focusing module.

### BACKGROUND OF THE INVENTION

### 1. Field of the Invention

The present invention relates to a focus compensation method and a projector device, and more particularly, to a focus compensation method of effectively preventing image abnormality and a related projector device.

### 2. Description of the Prior Art

A conventional non-fixed focus lens has multiple elements assembled as the zooming module and the focusing module; gaps are existed between the assembled elements, which may cause the zooming module to produce idle travel during the operation, and position of the zooming module may be often misjudged, so that the focusing module produces blurry resolution during autofocus process and requires additional compensation, and therefore results in a jitter defect of the projection image. That is, design of a focus compensation method of applying to the common non-fixed focus lens and preventing the projection image from shaking without extra hardware configuration cost is an important issue in the projection apparatus industry.

### SUMMARY OF THE INVENTION

The present invention provides a focus compensation method of effectively preventing image abnormality and a related projector device for solving above drawbacks.

According to the claimed invention, a focus compensation method is applied to a non-fixed focus lens, and the non-fixed focus lens has a zooming module and a focusing module. The focus compensation method includes utilizing the zooming module to acquire a zooming angle of the non-fixed focus lens, acquiring a transformation relation between the zooming angle and a focusing angle of the non-fixed focus lens, acquiring a focused correction parameter of the non-fixed focus lens relevant to the zooming angle in accordance with the transformation relation, and utilizing the focused correction parameter to adjust the focusing module for executing backlash compensation of an auto focusing function of the non-fixed focus lens. The zooming module is not synchronized with the focusing module.

According to the claimed invention, a projector device includes a non-fixed focus lens, a driver mechanism and an operation processor. The non-fixed focus lens has a zooming module and a focusing module, and the zooming module is not synchronized with the focusing module. The driver mechanism is electrically connected with the focusing module. The operation processor is electrically connected with the driver mechanism, and adapted to utilize the zooming module to acquire a zooming angle of the non-fixed focus lens, acquire a transformation relation between the zooming angle and a focusing angle of the non-fixed focus lens, acquire a focused correction parameter of the non-fixed focus lens relevant to the zooming angle in accordance with the transformation relation, and utilize the focused correction parameter to adjust the focusing module for executing backlash compensation of an auto focusing function of the non-fixed focus lens.

The present invention can provide the focus compensation method and the related projector device applied for the non-fixed focus lens, and the non-fixed focus lens has the zooming module not synchronized with the focusing module; when the zooming angle is adjusted by the zooming module, the present invention does not activate the zooming module, and can only utilize the focused correction parameter to adjust the focusing module for executing the backlash compensation of the auto focusing function of the non-fixed focus lens, so as to effectively achieve design purposes of ensuring normal resolution and avoiding the jitter defect in the projection image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a projector device according to an embodiment of the present invention.

FIG. 2 is a flow chart of a focus compensation method according to the embodiment of the present invention.

FIG. 3 and FIG. 4 are diagrams of zooming angles acquired by a non-fixed focus lens in different directions according to a first embodiment of the present invention.

FIG. 5 is a diagram of the transformation relation computed by the non-fixed focus lens according to a second embodiment of the present invention.

FIG. 6 is a diagram of the transformation relation computed by the non-fixed focus lens according to a third embodiment of the present invention.

### DETAILED DESCRIPTION

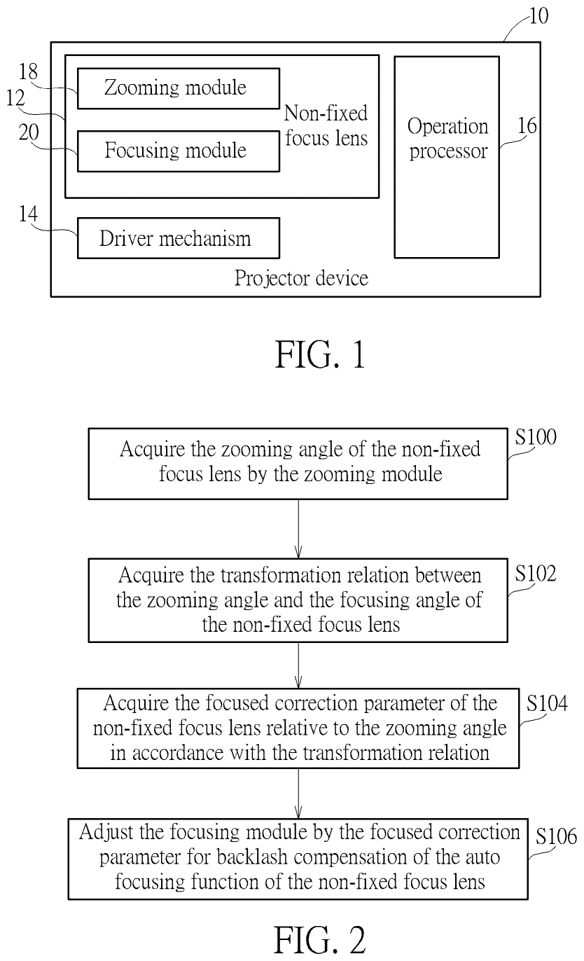

Please refer to FIG. 1. FIG. 1 is a functional block diagram of a projector device 10 according to an embodiment of the present invention. The projector device 10 can include a non-fixed focus lens 12, a driver mechanism 14 and an operation processor 16. The non-fixed focus lens 12 can have a zooming module 18 and a focusing module 20, and the zooming module 18 is not synchronized with the focusing module 20. The driver mechanism 14 can be connected to the non-fixed focus lens 12. The operation processor 16 can be electrically connected with the driver mechanism 14. The non-fixed focus lens 12 can include several elements assembled as the zooming module 18 and the focusing module 20; there are usually gaps existed between the assembled elements, which may cause the zooming module 18 to produce an idle stroke during operation, and result in position misjudgment of the zooming module 18, so that the focusing module 20 may produce blurry resolution in automatic focusing process and therefore require extra compensation, which can cause the jitter defect of the projection image. The operation processor 16 can execute a focus compensation method of the present invention to overcome the jitter defect of the projection image.

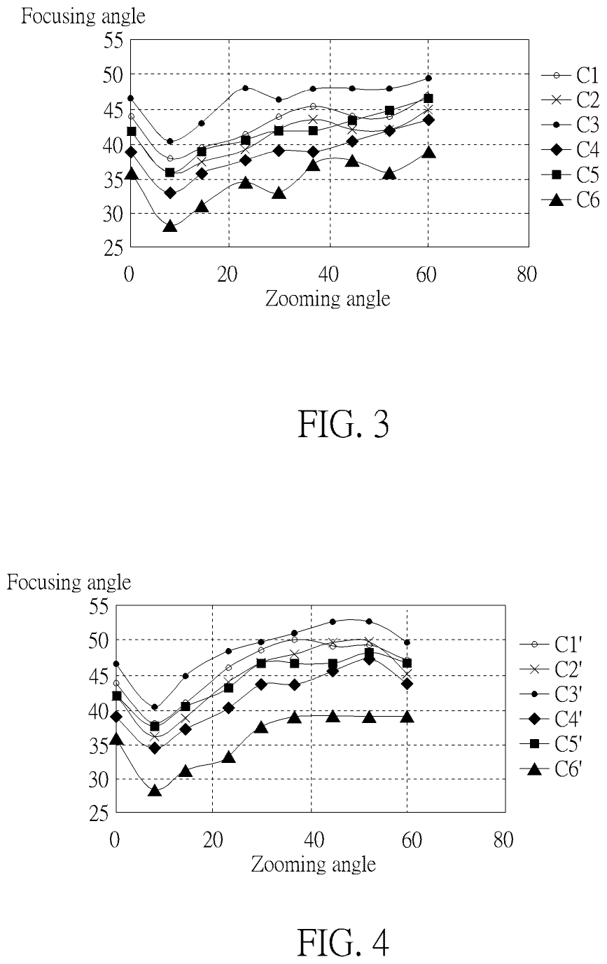

Please refer to FIG. 2 to FIG. 4. FIG. 2 is a flow chart of the focus compensation method according to the embodiment of the present invention. FIG. 3 and FIG. 4 are diagrams of zooming angles acquired by the non-fixed focus lens 12 in different directions according to a first embodiment of the present invention. First, step S100, step S102 and step S104 can be executed to acquire the zooming angle of the non-fixed focus lens 12 by the zooming module 18, acquire a transformation relation between the zooming angle and a focusing angle of the non-fixed focus lens 12, and acquire a focused correction parameter of the non-fixed focus lens 12 relative to the zooming angle in accordance with the transformation relation. The present invention can apply the focus compensation method for several types of the non-fixed focus lens 12, and the non-fixed focus lens 12 can have two adjustment modes of forward rotation and reverse rotation. As shown in FIG. 3, variation of the focused correction parameter of the non-fixed focus lens 12 with several types in the forward rotation can be exampled by calibration curves C1, C2, C3, C4, C5 and C6; as shown in FIG. 4, variation of the focused correction parameter of the non-fixed focus lens 12 with several types in the reverse rotation can be exampled by the calibration curves C1′, C2′, C3′, C4′, C5′ and C6′.

In step S102, the focus compensation method can acquire several forward transformation curves about the zooming angle and the focusing angle of the plural non-fixed focus lenses 12 in the forward rotation mode, such as the forward transformation curves C1, C2, C3, C4, C5 and C6, and compute angle computation values of the forward transformation curves C1, C2, C3, C4, C5 and C6, such as a mean value of the focusing angles of each of the curves at each zooming angle, so as to acquire forward transformation relation; in addition, the focus compensation method can further acquire several reverse transformation curves about the zooming angle and the focusing angle of the plural non-fixed focus lens 12 in the reverse rotation mode, such as the reverse transformation curves C1′, C2′, C3′, C4′, C5′ and C6′, and then compute the angle computation values of the reverse transformation curves C1′, C2′, C3′, C4′, C5′ and C6′, such as the mean value of the focusing angles of each of the curves at each zooming angle, so as to acquire reverse transformation relation.

Then, according to user's adjustment for the zooming module 18 of the non-fixed focus lens 12, the focus compensation method of the present invention can analyze the zooming result of the zooming module 18 to determine whether the non-fixed focus lens 12 belongs to a forward transformation mode or a reverse rotation mode, so as to decide the forward transformation relation or the reverse transformation relation can be served as the transformation relation in step S102. When the transformation relation in step S102 is decided, and the focused correction parameter is acquired by the transformation relation in step S104, the focus compensation method of the present invention can execute step S106 to adjust the focusing module 20 by the focused correction parameter so as to apply for executing backlash compensation of an auto focusing function of the non-fixed focus lens 12. That is to say, the focus compensation method of the present invention can collect the transformation curves about the zooming angle and the focusing angle of the lenses with various types in the forward rotation mode and the reverse rotation mode, and compute the mean value to acquire the transformation relation between the zooming angle and the focusing angle after integration; therefore, the focus compensation method can find out the suitable focused correction parameter from the foresaid transformation relations in accordance with the zooming angle based on the adjusted zooming module 18, and the focused correction parameter can be used to adjust the focusing module 20 for executing the backlash compensation of the non-fixed focus lens 12. In the meantime, the zooming angle of the zooming module 18 is not changed.

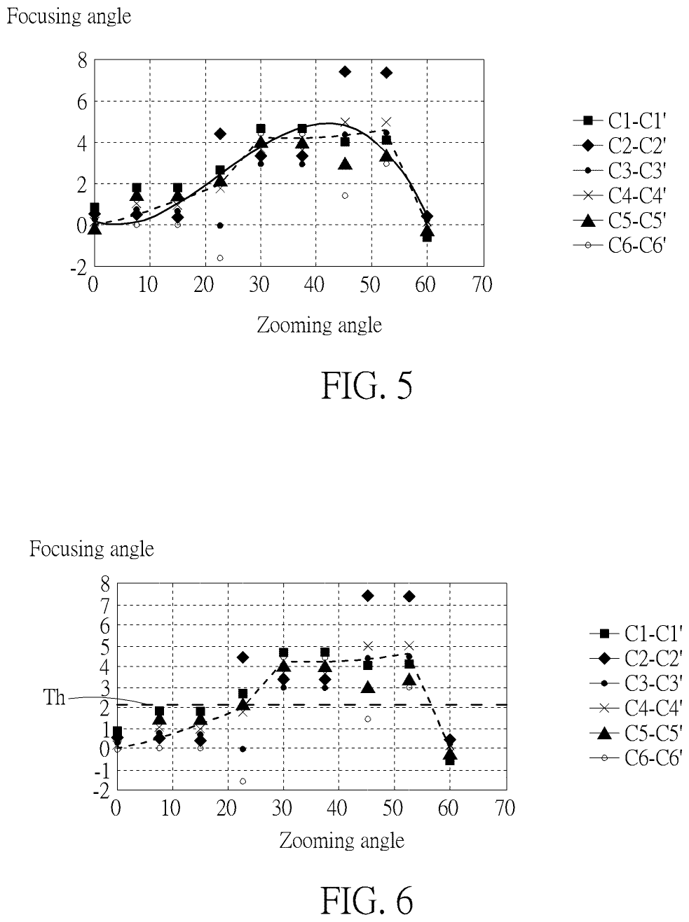

Please refer to FIG. 5. FIG. 5 is a diagram of the transformation relation computed by the non-fixed focus lens 12 according to a second embodiment of the present invention. In the second embodiment, when executing step S102, the focus compensation method can acquire two related focusing angles of the non-fixed focus lens 12 with the same type respectively in the forward rotation mode and the reverse rotation mode at each zooming angle, and compute a focusing angle difference of the two related focusing angles; therefore, several focusing angle differences can be acquired due to various types of the non-fixed focus lens 12. After that, the focus compensation method can compute a focusing angle difference computation value (such as a focusing angle difference mean value) of the focusing angle differences corresponding to each zooming angle, for generating the transformation relation (such as a dashed curve shown in FIG. 5) required in step S102. Accordingly, the focus compensation method of the present invention can optionally use curve fitting technology to calibrate several focusing angle difference computation values, and utilize the calibrated focusing angle difference computation values to draw the curve for setting as the transformation relation (such as a solid curve shown in FIG. 5) required in step S102.

Please refer to FIG. 6. FIG. 6 is a diagram of the transformation relation computed by the non-fixed focus lens 12 according to a third embodiment of the present invention. In the third embodiment, when executing step S102 and step S104, the focus compensation method can acquire two related focusing angles of the non-fixed focus lens 12 with the same type respectively in the forward rotation mode and the reverse rotation mode at each zooming angle, and compute the focusing angle difference of the two related focusing angles; thus, several focusing angle differences can be acquired due to the various types of the non-fixed focus lens 12, and the focus compensation method can compute the focusing angle difference computation value (such as the focusing angle difference mean value) of the focusing angle differences corresponding to each zooming angle, for generating the transformation relation (such as the dashed curve shown in FIG. 6) required in step S102.

Besides, the focus compensation method in the third embodiment can select one of the several focusing angle difference computation values to set as the focused correction parameter for fixed value compensation in accordance with a preset condition. The preset condition can be a maximal value of the focusing angle difference computation values; the focus compensation method can compute a preset ratio of the focusing angle difference computation value (such as the maximal value of the focusing angle difference computation values) for being a compensation threshold Th. In the third embodiment, fifty percent can be used as the preset ratio, but actual application of the preset ratio is not limited to the foresaid embodiment. When the compensation threshold Th is computed, the focus compensation method can compare the focusing angle difference computation values with the compensation threshold Th. If one or some of the focusing angle difference computation values are smaller than or equal to the compensation threshold Th, such as mark points lower than the compensation threshold Th, the focus compensation method does not adjust the focusing module 20; if one or some of the focusing angle difference computation values are greater than the compensation threshold Th, such as other mark points higher than the compensation threshold Th, the focus compensation method can utilize the focused correction parameter to adjust the focusing module 20.

In conclusion, the present invention can provide the focus compensation method and the related projector device applied for the non-fixed focus lens, and the non-fixed focus lens has the zooming module not synchronized with the focusing module; when the zooming angle is adjusted by the zooming module, the present invention does not activate the zooming module, and can only utilize the focused correction parameter to adjust the focusing module for executing the backlash compensation of the auto focusing function of the non-fixed focus lens, so as to effectively achieve design purposes of ensuring normal resolution and avoiding the jitter defect in the projection image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A focus compensation method applied to a non-fixed focus lens, the non-fixed focus lens having a zooming module and a focusing module, the focus compensation method comprising:
utilizing the zooming module to acquire a zooming angle of the non-fixed focus lens;
acquiring a transformation relation between the zooming angle and a focusing angle of the non-fixed focus lens;
acquiring a focused correction parameter of the non-fixed focus lens relevant to the zooming angle in accordance with the transformation relation; and
utilizing the focused correction parameter to adjust the focusing module for executing backlash compensation of an auto focusing function of the non-fixed focus lens;
wherein the zooming module is not synchronized with the focusing module.

2. The focus compensation method of claim 1, wherein the focus compensation method does not change the zooming angle of the zooming module when the focusing module executes the backlash compensation via the focused correction parameter.

3. The focus compensation method of claim 1, wherein acquiring the transformation relation between the zooming angle and the focusing angle of the non-fixed focus lens comprises:
acquiring a forward transformation relation between the zooming angle and the focusing angle of a plurality of non-fixed focus lenses in a forward rotation mode;
acquiring a reverse transformation relation between the zooming angle and the focusing angle of the plurality of non-fixed focus lenses in a reverse rotation mode; and
analyzing a zooming adjustment result of the zooming module to decide whether the forward transformation relation or the reverse transformation relation is served as the transformation relation.

4. The focus compensation method of claim 3, wherein the focus compensation method further comprises:
acquiring a plurality of forward transformation curves about the zooming angle and the focusing angle of the plurality of non-fixed focus lenses in the forward rotation mode; and
computing an angle computation value of the plurality of forward transformation curves to generate the forward transformation relation;
wherein the focus compensation method further comprises:
acquiring a plurality of reverse transformation curves about the zooming angle and the focusing angle of the plurality of non-fixed focus lenses in the reverse rotation mode; and
computing an angle computation value of the plurality of reverse transformation curves to generate the reverse transformation relation.

5. The focus compensation method of claim 1, wherein acquiring the transformation relation between the zooming angle and the focusing angle of the non-fixed focus lens comprises:
acquiring a plurality of focus angle differences in several zooming angles of a plurality of non-fixed focus lenses between a forward rotation mode and a reverse rotation mode; and
computing several focusing angle difference computation values of the plurality of focus angle differences at the several zooming angles to generate the transformation relation.

6. The focus compensation method of claim 5, wherein the focus compensation method further comprises:
utilizing curve fitting technology to calibrate the several focusing angle difference computation values for generating the transformation relation.

7. The focus compensation method of claim 5, wherein acquiring the focused correction parameter of the non-fixed focus lens relevant to the zooming angle in accordance with the transformation relation further comprises:
selecting one of the several focusing angle difference computation values for setting as the focused correction parameter in accordance with a preset condition.

8. The focus compensation method of claim 7, wherein the preset condition is a maximal value of the several focusing angle difference computation values.

9. The focus compensation method of claim 7, wherein the focus compensation method further comprises:
computing a preset ratio of the selected focusing angle difference computation value for setting as a compensation threshold;
comparing the several focusing angle difference computation values with the compensation threshold; and
utilizing the focused correction parameter to adjust the focusing module when any of the several focusing angle difference computation values is greater than the compensation threshold.

10. The focus compensation method of claim 9, wherein the focus compensation method further comprises:
keeping the focusing module unchanged when any of the several focusing angle difference computation values is smaller than or equal to the compensation threshold.

11. A projector device, comprising:
a non-fixed focus lens, having a zooming module and a focusing module, the zooming module being not synchronized with the focusing module;
a driver mechanism electrically connected with the focusing module; and
an operation processor electrically connected with the driver mechanism, and adapted to utilize the zooming module to acquire a zooming angle of the non-fixed focus lens, acquire a transformation relation between the zooming angle and a focusing angle of the non-fixed focus lens, acquire a focused correction parameter of the non-fixed focus lens relevant to the zooming angle in accordance with the transformation relation, and utilize the focused correction parameter to adjust the focusing module for executing backlash compensation of an auto focusing function of the non-fixed focus lens.

12. The projector device of claim 11, wherein the focus compensation method does not change the zooming angle of the zooming module when the focusing module executes the backlash compensation via the focused correction parameter.

13. The projector device of claim 11, wherein the operation processor is adapted to further acquire a forward transformation relation between the zooming angle and the focusing angle of a plurality of non-fixed focus lenses in a forward rotation mode, acquire a reverse transformation relation between the zooming angle and the focusing angle of the plurality of non-fixed focus lenses in a reverse rotation mode, and analyze a zooming adjustment result of the zooming module to decide whether the forward transformation relation or the reverse transformation relation is served as the transformation relation.

14. The projector device of claim 13, wherein the operation processor is adapted to further acquire a plurality of forward transformation curves about the zooming angle and the focusing angle of the plurality of non-fixed focus lenses in the forward rotation mode, and compute an angle computation value of the plurality of forward transformation curves to generate the forward transformation relation; the operation processor is adapted to further acquire a plurality of reverse transformation curves about the zooming angle and the focusing angle of the plurality of non-fixed focus lenses in the reverse rotation mode, and compute an angle computation value of the plurality of reverse transformation curves to generate the reverse transformation relation.

15. The projector device of claim 11, wherein the operation processor is adapted to further acquire a plurality of focus angle differences in several zooming angles of a plurality of non-fixed focus lenses between a forward rotation mode and a reverse rotation mode, and compute several focusing angle difference computation values of the plurality of focus angle differences at the several zooming angles to generate the transformation relation.

16. The projector device of claim 15, wherein the operation processor is adapted to further utilize curve fitting technology to calibrate the several focusing angle difference computation values for generating the transformation relation.

17. The projector device of claim 15, wherein the operation processor is adapted to further select one of the several focusing angle difference computation values for setting as the focused correction parameter in accordance with a preset condition.

18. The projector device of claim 17, wherein the preset condition is a maximal value of the several focusing angle difference computation values.

19. The projector device of claim 17, wherein the operation processor is adapted to further compute a preset ratio of the selected focusing angle difference computation value for setting as a compensation threshold, compare the several focusing angle difference computation values with the compensation threshold, and utilize the focused correction parameter to adjust the focusing module when any of the several focusing angle difference computation values is greater than the compensation threshold.

20. The projector device of claim 19, wherein the operation processor is adapted to further keep the focusing module unchanged when any of the several focusing angle difference computation values is smaller than or equal to the compensation threshold.
